(19) United States
(12) Patent Application Publication
(10) Pub. No.: US 2010/0242691 A1
(43) Pub. Date: Sep. 30, 2010

(54) TORQUE ADJUSTING STRUCTURE FOR POWER TOOLS

(76) Inventor: Chih-Ching HSIEH, Fongyuan City (TW)

Correspondence Address: Wang Law Firm, Inc., 4989 Peachtree Parkway,, Suite 200, Norcross, GA, 30092, US

(21) Appl. No.: 12/411,690

(22) Filed: Mar. 26, 2009

(51) Int. Cl. B25B 23/14; B23Q 5/00

(52) U.S. Cl. 81/467; 173/176

(57) ABSTRACT

A torque adjusting structure for power tools includes an accommodating device and a torque device. The accommodating device has a head part and a body part. The head part is formed with a groove for the connection of a power tool. The bottom of the groove is provided with a power base on which power connecting points for electrical connection of the power tool are provided. It provides the required electrical power for the power tool to start. The torque device has an acting part and an adjusting part. The torque device connects to the body part of the accommodating device using one end of the acting part. The other end of the acting part connects to the adjusting part.

### BACKGROUND OF THE INVENTION

1. Field of Invention

The invention relates to a torque adjusting structure and, in particular, to a torque adjusting structure for power tools.

2. Related Art

Power tools are common tools used by car maintenance mechanics and machine manufacturers. They are often used to fasten or loosen parts. They require an external power source for operations. However, conventional power tools do not have torque adjusting devices. Therefore, if the assembly requires precision torque controls, such as engine cases, cylinders, and clutches, it has to be done manually using a torque wrench. This inevitably increases the operation time and lowers the work efficiency. It is thus imperative to provide a solution.

### SUMMARY OF THE INVENTION

An objective of the invention is to provide a torque adjusting structure for a power tool so that the power tool can adjust its torque while in use.

To achieve the above-mentioned objective, the disclosed torque adjusting structure for a power tool includes an accommodating device and a torque device.

The accommodating device has a head part and a body part. The head part has a groove for a power tool to mount. The bottom of the groove has a power base on which electrical connecting points are provided for the power tool to electrically connect. It provides the electrical power for the power tool.

The torque device has an acting part and an adjusting part. One end of the acting part connects to the body part of the accommodating device. The other end of the acting part connects to the adjusting part.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a schematic view of the invention in use, showing the state when the power tool is mounted onto the invention;

FIG. 3 is a cross-sectional view of the invention in use;

FIG. 4 is a three-dimensional view of another embodiment of the invention; and

FIG. 5 is a schematic view of another embodiment of the invention in use, showing the state when the power tool is mounted onto the invention.

### DETAILED DESCRIPTION OF THE INVENTION

The present invention will be apparent from the following detailed description, which proceeds with reference to the accompanying drawings, wherein the same references relate to the same elements.

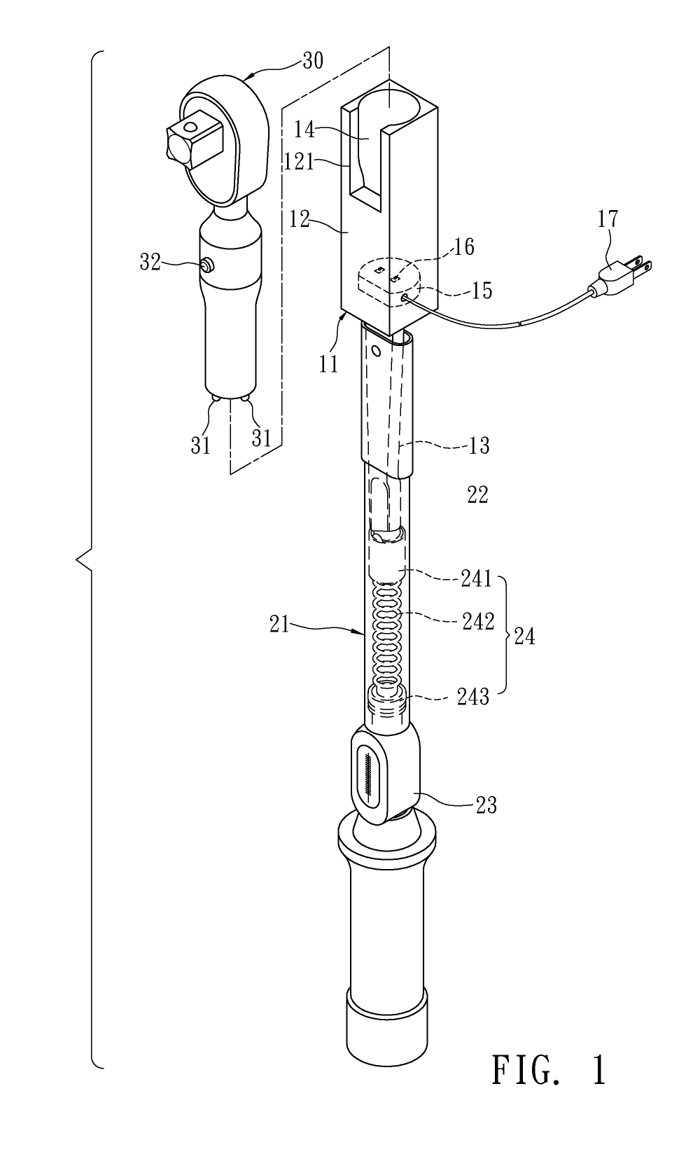

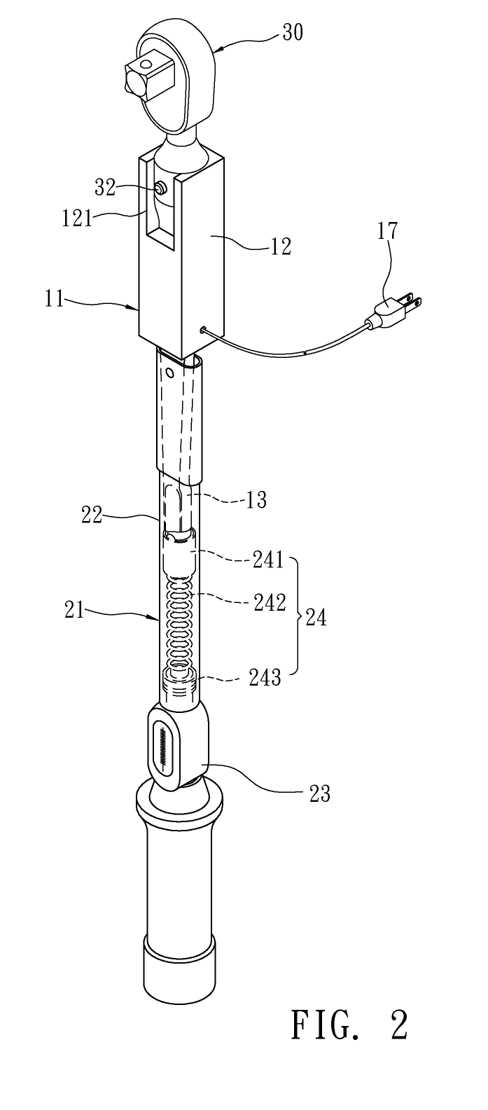

Please refer to FIGS. 1 and 2. The torque adjusting structure for power tools mainly includes an accommodating device 11 and a torque device 21.

The accommodating device 11 has a head part 12 and a body part 13 having a long handle shape. The head part 12 of the accommodating device 11 is recessed to form a hollow groove 14. In this embodiment, at least one side of the head part 12 has an opening 121 in communication with the groove 14. The shape of the inner edge of the groove 14 exactly corresponds to the outer edge of a power tool 30. The power tool 30 can be mounted onto the groove 14 of the accommodating device 11 by tight fit. The bottom of the groove 14 is provided with a power base 15. The power base 15 has power connecting points 16 for an electrical connection with the electrical terminal 31 of the power tool 30. The power base 15 is further externally connected with a power plug 17 for supplying electrical power to the power base 15. When the power tool 30 is mounted onto the groove 14, the power connecting points 16 on the base exactly urge against the electrical terminal 31 of the power tool 30, providing the electrical power required by the power tool 30. Moreover, the power tool 30 has a switch 32. When the power tool 30 is mounted onto the groove 14 of the accommodating device 11, the switch 32 corresponds to the opening 121 of the head part 11.

The torque device 21 has an acting part 22 and an adjusting part 23. The acting part 22 is a hollow tube, with a supporting assembly 24 installed therein. The supporting assembly 24 consists of a top part 241, an elastic element 242, and a fixing base 243. The upper end of the top part 241 connects with the body part 13 of the accommodating device 11. The lower end of the top part 241 connects to one end of the elastic element 242. The other end of the elastic element 242 connects with the fixing base 243. The fixing base 243 is further connected with the adjusting part 23. The adjusting part 23 enables the user to adjust the torque magnitude according to the operation needs. It urges against the elastic element 242 of the supporting assembly 24. Accordingly, the elastic element 242 of the supporting assembly 24 contracts or relaxes according to the adjusted value of torque.

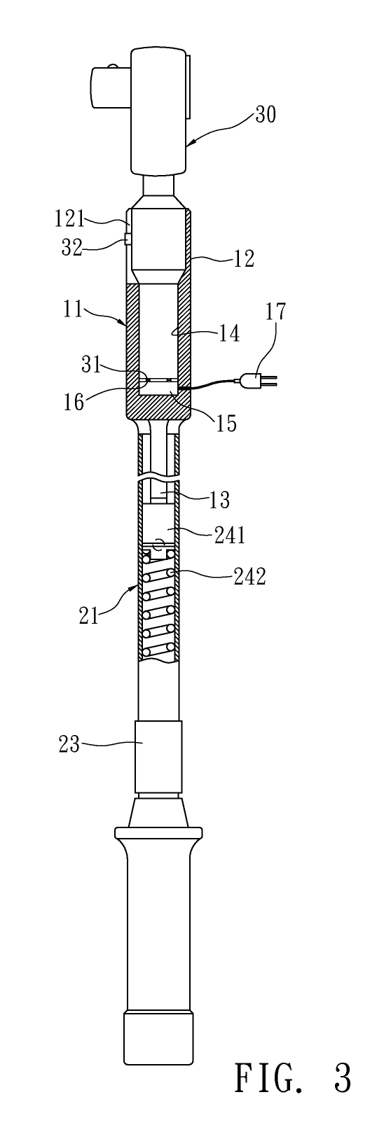

Please refer to FIG. 3. When the invention is in use, the power tool 30 is first mounted onto the groove 14 of the accommodating device 11 by tight fit. The power connecting points 16 of the power base 15 urge against the electrical terminal 31 of the power tool 30. Therefore, the power tool 30 operates under the power obtained via the power base 15. When the user operates the power tool 30 to fasten or loosen a bolt or nut and reaches the predetermined torque, the lower end of the body part 13 of the accommodating device 11 escapes from the top part 241 of the supporting assembly 24 because the force provided by the elastic element 242 of the supporting assembly 24 is insufficient. The power tool 30 thus does not further fasten or loosen the bolt or nut. This prevents over-fastening of nuts or bolts. The user is able to adjust the torque while using a power tool 30. Moreover, the invention makes the mounting and dismounting of the power tool 30 faster and easier by tight fit.

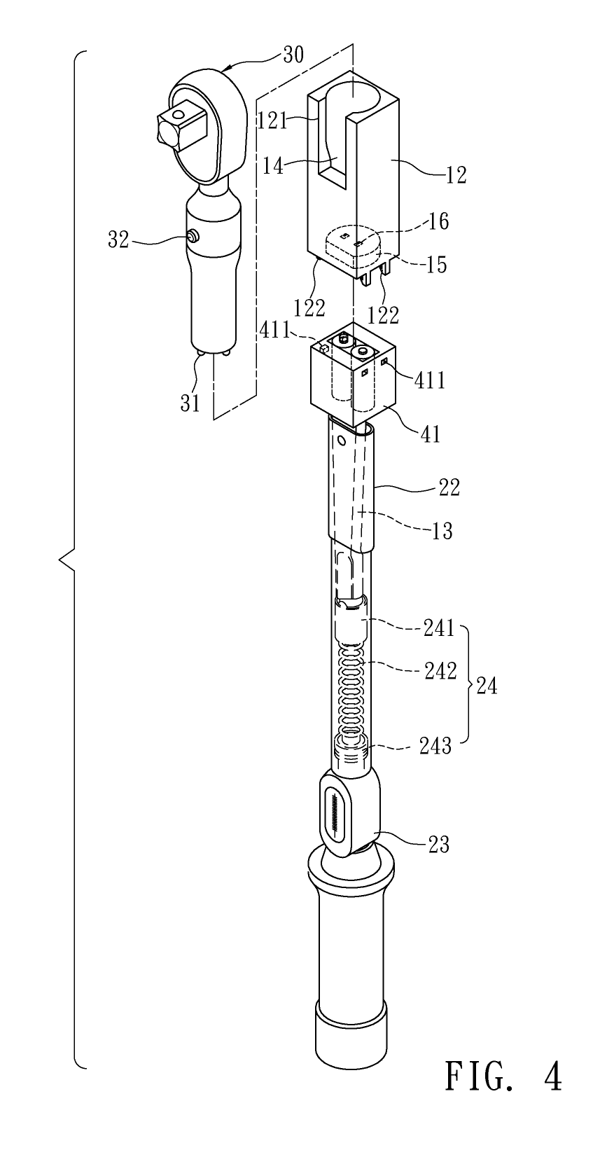

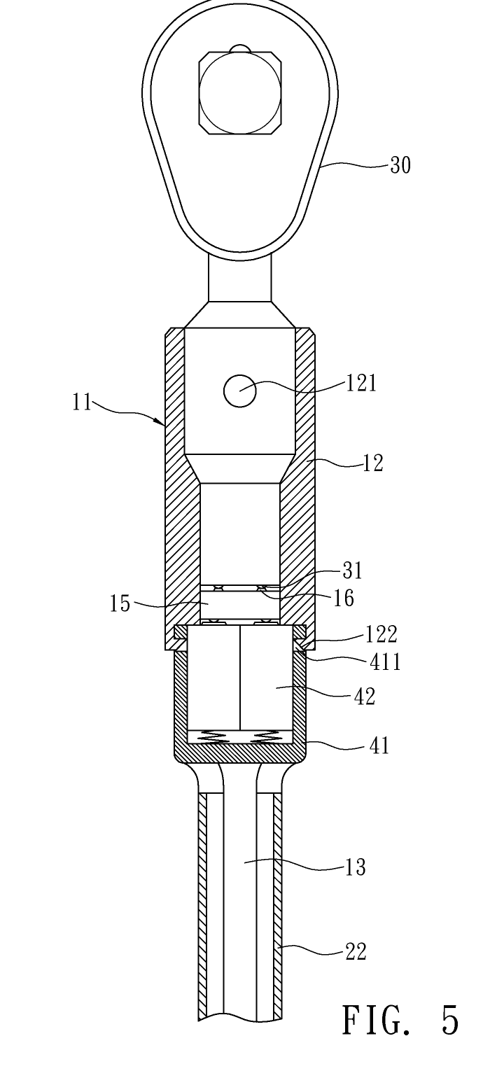

FIGS. 4 and 5 show another embodiment of the invention. It differs form the previous embodiment in that the side edge of the head part 12 of the accommodating device 11 is protruded with several hook parts 122. A battery set 41 is connected to the end of the body part 13 of the accommodating device 11 far from the supporting assembly 24 of the torque device 21. The battery set 41 has a connecting part 411 corresponding to the hook parts 122. The hook parts 122 on the head part 12 match with the connecting part 411 of the battery set 41, so that the battery set 15 in the head part 12 are in electrical connection with the batteries 42 inside the battery set 41, thereby powering the power base 15. In this case, the disclosed torque adjusting structure does not need to have an external connection. The user is thus free from the interference of a power cord. This makes the invention more convenient in operations.

According to the above detailed description, it is clear that the disclosed torque adjusting structure for a power tool can achieve the goals of adjusting the torque when a user operates the power tool and easy mounting or dismounting of the power tool. It thus has a great improvement over the prior art.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

1. A torque adjusting structure for a power tool, comprising an accommodating device and a torque device;
wherein the accommodating device has a head part and a body part, the head part is formed with a groove for the connection of the power tool and having a power base with power connecting points for electrical connection with and supplying the electrical power to the power tool; and
the torque device has an acting part and an adjusting part, one end of the acting part being connected with the body part of the accommodating device and the other end thereof being connected with the adjusting part.

2. The torque adjusting structure for a power tool of claim 1, wherein the inner edge of the groove has a shape matching the outer edge of the power tool so that the power tool is mounted onto the groove of the accommodating device through tight fit.

3. The torque adjusting structure for a power tool of claim 1, wherein at least one side of the head part has an opening in communication with the groove, the power tool has a switch, and the switch corresponds to the opening of the head part when the power tool is mounted onto the groove of the accommodating device.

4. The torque adjusting structure for a power tool of claim 1, wherein the power tool has an electrical terminal, a power plug is connected outside the power base, and the power connecting points on the base urge against the electrical terminal of the power tool when the power tool is mounted onto the groove

5. The torque adjusting structure for a power tool of claim 1, wherein the side edge of the head part of the accommodating device is protruded with several hook parts, the end of the body part of the accommodating device far from the torque device is connected with a battery set, the battery set has a connecting part corresponding to the hook parts, and the hook parts on the head parts connect to the connecting part of the battery set so that the power base in the head part and the battery set are in electrical communications, thereby powering the power base.

6. The torque adjusting structure for a power tool of claim 1, wherein the acting part is a hollow tube with a supporting element installed therein; the supporting assembly consists of an urging part, an elastic element, and affixing base; the upper end of the urging part connects to the body part of the accommodating device, and the lower end thereof connects to one end of the elastic element; the other end of the elastic element connects with the fixing base, and the fixing base connects with the adjusting part; the adjusting part has an adjustable torque to urge against the elastic element of the supporting assembly according to operation, so that the elastic element of the supporting assembly tightens or loosens according to the torque value.
